(19) United States
(12) Patent Application Publication
(10) Pub. No.: US 2004/0010456 A1
(43) Pub. Date: Jan. 15, 2004

(54) Incrementally updated electronic catalog with localized distribution

(76) Inventor: Khoi Nhu Hoang, Pleasanton, CA (US)

Correspondence Address: PERKINS COIE LLP, P.O. BOX 2168, MENLO PARK, CA, 94026, US

(21) Appl. No.: 10/192,737

(22) Filed: Jul. 9, 2002

(51) Int. Cl. G06F 17/60

(52) U.S. Cl. 705/27

(57) ABSTRACT

The present invention contemplates a variety of improved electronic catalog techniques including client generic broadcast of electronic catalog data, incremental electronic catalog updates, and regional processing (e.g., local distribution) of customer requests. The client generic broadcast of electronic catalog data de-couples bandwidth requirements from the number of serviced clients. Incremental catalog updates further minimize bandwidth requirements as catalogs can be updated without distribution of an updated catalog in its entirety. Through localized processing, the present invention inherently provides the customer a better mechanism for purchasing and receiving product via an electronic catalog, and provides the vendor a better platform for tracking and allocating resources. Although these several aspects of the present invention are described below as a complete, homogenous system, those skilled in the art will recognize that each aspect of the invention has significant individual benefits and may be implemented separately as desired by the system designer and/or called for by the specific application.

### CROSS-REFERENCE TO RELATED APPLICATIONS

Not applicable.

### STATEMENT REGARDING FEDERALLY SPONSORED RESEARCH

Not applicable.

### BACKGROUND OF INVENTION

1. Field of Invention

The present invention relates to electronic catalogs and more specifically to client generic distribution of electronic catalog data, incremental electronic catalog updates, and localized customer request processing over a wide area network.

2. Description of Related Art

Sales of goods and services through paper catalogs have long been a favored means of sales professionals and many private consumers. The traditional method of catalog sales consists of publishing a paper catalog listing the groups of products or services for sale, including illustrative pictures and related information such as size, color, pricing and terms of sale. Industrial clients have also favored the use of paper catalogs for fulfilling their various procurement needs.

Paper catalogs are very bulky and costly to distribute. Furthermore, paper catalog updates can be wasteful, expensive and untimely. In the case of bound catalogs, any meaningful catalog update requires publication and distribution of an entirely new catalog.

With the advent of personal computers and electronic networking, the traditional paper catalog has been supplemented by electronic catalogs that utilize a variety of electronic media. While electronic media certainly enables a whole new realm of catalog marketing and customer access, a host of new technology must be developed and corresponding problems do arise.

Some prior art electronic catalog systems have attempted to facilitate the ordering of items from suppliers. King et al.'s U.S. Pat. No. 5,319,542 is a typical example of prior art efforts to provide an electronic catalog to a plurality of users. King teaches an electronic catalog system providing a master catalog used to generate a public catalog accessible to multiple clients and private catalogs accessible to single clients. According to King, the electronic catalog is updated by rebuilding the master catalog and then electronically publishing the updated master catalog in its entirety to clients hosting public or private electronic catalogs.

Although effective in that multiple users are provided an electronically updateable catalog, King has a variety of shortcomings that are typical of the prior art. For example, King's electronic catalog publishing system is a one-to-one communication link between the master catalog and each secondary catalog. Hence King's bandwidth requirements for distribution and update are directly proportional to the number of clients provided the electronic catalog information. Furthermore, any update to an electronic catalog requires publishing a new electronic catalog in its entirety, as no mechanism in the prior art teaches a method for incrementally updating an electronic catalog.

Other prior electronic catalog systems have concentrated on resolving issues surrounding the creation of an electronic catalog such as Wong et al.'s U.S. Pat. No. 5,890,175 and Lockwood's U.S. Pat. No. 5,576,951. Both systems teach various methods for generating pages of an electronic catalog and in some cases teach customizing the electronic catalog display to meet the needs of the particular client and/or merchant. Some of these approaches have been directed at hosting an electronic catalog at a central server and allowing access to the pages of the catalog by means of various links. Again, these approaches have bandwidth requirements proportional to the number of clients, and do not directly provide for incremental updates.

With the increasing popularity of the Internet, it is readily apparent that the use of this popular medium to sell products and services can only proliferate. The increasing power of set-top-boxes gives rise to the possibility of using these powerful devices as means of commercial communications over a wide area network. Thus current and evolving platforms demand bandwidth efficient electronic catalog publishing techniques that are not in existence. These techniques should take advantage of the client generic nature of most electronic catalog data and provide incremental updating of electronic catalog without requiring mass distribution of an updated electronic catalog in its entirety.

### SUMMARY OF THE INVENTION

The present invention contemplates a variety of improved electronic catalog techniques including client generic broadcast of electronic catalog data, incremental electronic catalog updates, and regional processing (e.g., local distribution) of customer requests. The client generic broadcast of electronic catalog data de-couples bandwidth requirements from the number of serviced clients. Incremental catalog updates further minimize bandwidth requirements as catalogs can be updated without distribution of an updated catalog in its entirety. Through localized processing, the present invention inherently provides the customer a better mechanism for purchasing and receiving product via an electronic catalog, and provides the vendor a better platform for tracking and allocating resources. Although these several aspects of the present invention are described below as a complete, homogenous system, those skilled in the art will recognize that each aspect of the invention has significant individual benefits and may be implemented separately as desired by the system designer and/or called for by the specific application.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a client generic electronic catalog publishing system within a wide area network having localized distribution according to a first embodiment of the present invention;

FIG. 2 is a flow chart illustrating one method for broadcast and incremental update of an electronic catalog over a wide area network, according to one embodiment of the present invention;

FIG. 3 is a flow chart illustrating one method for a client to provide an electronic catalog to a user in accordance with yet another embodiment of the present invention;

FIG. 4 is a pictorial illustration of a readily updateable electronic catalog database stored on a client in accordance with one aspect of the present invention; and

FIG. 5 is a flow chart illustrating a method for providing an electronic catalog to a user in accordance with another aspect of the present invention.

### DETAILED DESCRIPTION OF THE INVENTION

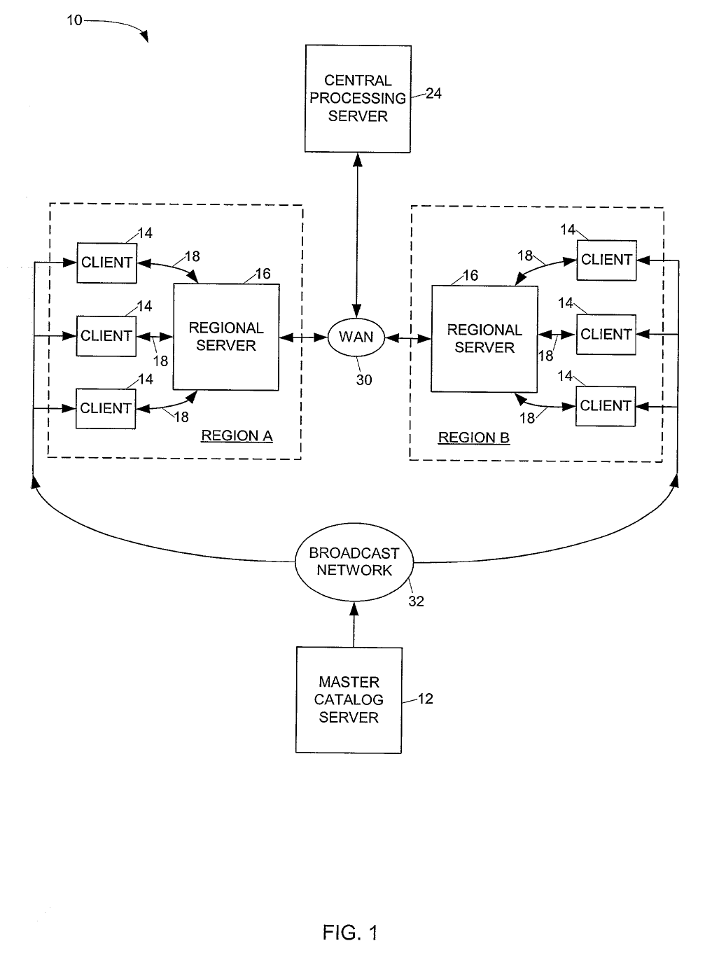

FIG. 1 illustrates an electronic catalog system 10 in accordance with one embodiment of the present invention. The electronic catalog system 10 provides a framework supporting client generic publishing of electronic catalog data, incremental updating of electronic catalogs, and localized purchasing and distribution. The electronic catalog system 10 includes a master catalog server 12, a plurality of regions such as region A and region B including clients 14 bi-directionally coupled to regional servers 16 through connections 18 as shown, and a centralized processing server 24.

The electronic catalog system 12 further includes a wide area network (WAN) 30 for bi-directionally coupling the regional servers 16 with the central processing server 24, and a broadcast network 32 enabling the master catalog server to broadcast electronic catalog data to the clients 14. Not shown in FIG. 1 are physical elements of the supply chain including local warehouses, physical services, etc.

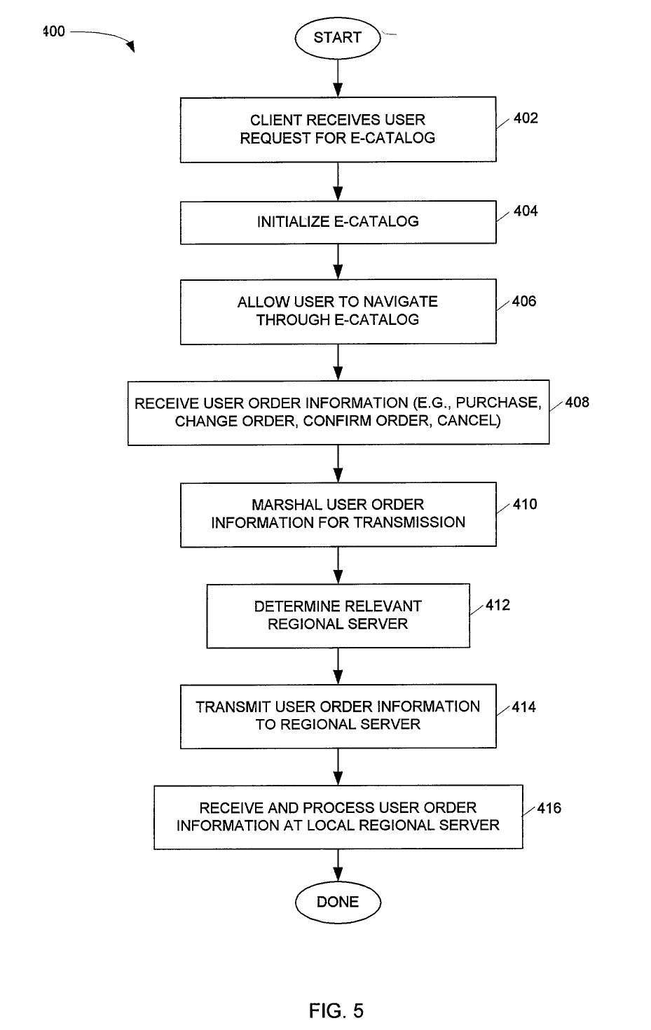

Clients 14 are placed within regions A and B based upon one or more region defining parameters such as geography, network constraints, or business reasons. For example, the clients 14 may be part of a specific region based on geographic proximity to a relevant regional server. As discussed below with reference to FIG. 5, defining regions based on geographic proximity enables efficient distribution systems. Alternatively, clients may be placed within a specific region based on a relationship with other clients of that specific region. For example, a region may be defined as a set of clients of a particular cable television network, or a geographic portion of the particular cable television network. This provides for customization of the electronic catalog system 10 as desired by the network designer and as called for by the specific application.

The master catalog server 12 is utilized to maintain, host, and broadcast electronic catalog data to the clients 14. Electronic catalog data includes a master electronic catalog and incremental electronic catalog updates. The master catalog server 12 can be utilized to provide other services associated with transacting business via electronic catalogs such as web hosting and order processing. The master catalog server 12 may be maintained and operated by, e.g., a company associated with the products and/or services presented in the electronic catalog, or a third party service provider may operate and maintain the electronic catalog on behalf of the relevant company.

Clients 14 are electronic devices such as a personal computer, personal digital assistant (PDA), web browser or a set-top-box (STB) suitable for providing an electronic catalog to a customer. Clients 14 are operable to receive and process client generic electronic catalog data, maintain the client generic electronic catalog data within an electronic catalog database, and generate an electronic catalog for use by a customer. The clients 14 receive electronic catalog data from the master catalog server 12 via the broadcast network 32.

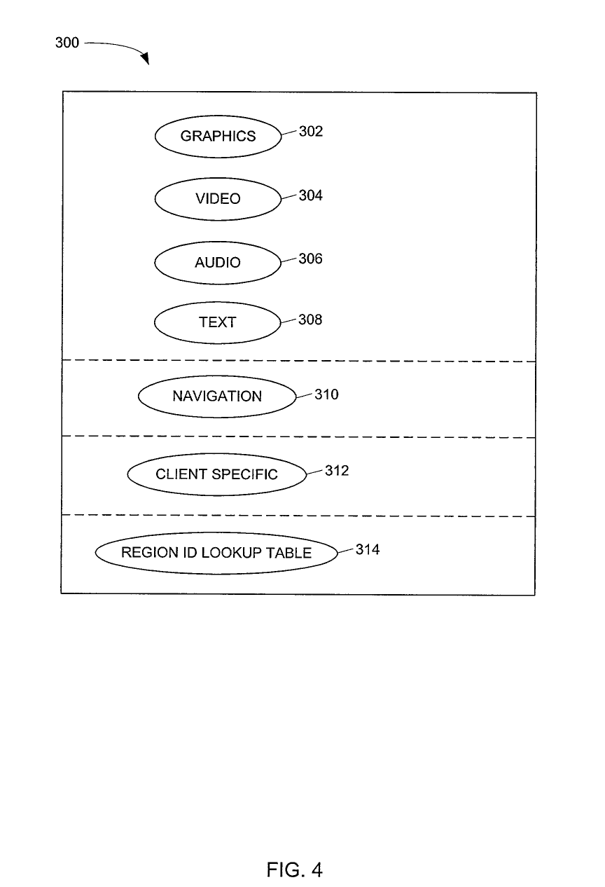

The regional servers 16 act as “local” servers for processing customer requests transmitted via corresponding clients. When geographical proximity is a region defining factor, it is contemplated that each regional server will be associated with one or more regional distribution centers or warehouses strategically located to provide localized distribution of product to clients. To facilitate localized distribution, one embodiment of the present invention teaches that electronic catalog orders are accomplished through a connection 18 made with a relevant regional server 16. For example, once a customer has made a purchase selection within an electronic catalog provided at a specific client 14, the specific client 14 may establish a telephone connection with the appropriate regional server 16 and place an order on behalf of the customer directly with the appropriate regional server 16. Several preferred embodiments for the operation of an electronic catalog from the client perspective are described below with reference to FIGS. 4 and 5.

The central processing server 24 is bi-directionally coupled to the regional servers 16 through the WAN 30 and provides for centralized processing in support of the local processing performed by the regional servers 16. Centralized processing may include receiving reports from the regional servers 16, tracking and maintaining inventory at regional distribution centers, and resolving issues not handled by the regional servers 16. For example, when a purchase order cannot be satisfied locally in a certain region, the appropriate region server 16 may pass along the order request to the centralized processing server 24 which in turn finds another region that can satisfy the order.

The broadcast network 32 is utilized to broadcast the electronic catalog to the plurality of clients 14 and 20. The broadcast network 32 may take the form of any suitable broadcast medium such as a satellite or terrestrial antenna broadcast network, a cable network, or the Internet.

In a related embodiment, a broadcast method is employed wherein each subscriber may simultaneously download multiple electronic files including data comprising an electronic catalog by simply selecting a download time and a download window at a particular time. The time length of the download window may be greater than or equal to time for downloading the largest file, or this data may be accumulated at the convenience of the receiver. In a client generic broadcast method, the electronic catalog may be periodically and simultaneously broadcast along with several other data files over a given period of time, over a given broadcast program channel. Whenever the client tunes to the given channel broadcasting the electronic catalog, he will download at least a portion of the data file corresponding to the content of the electronic catalog in a first time period within the download window. The client may download the remainder of the broadcast during the same download window or the missing data may be downloaded in a separate scheduled broadcast.

As will be appreciated, the electronic catalog system 12 of FIG. 1 may take on a variety of forms in actual implementation. For example, the communications medium comprising the WAN 30, the broadcast network 32, and the connections 18 may be a single network. In one preferred embodiment, the WAN 30 is the Internet, the broadcast network 32 is a digital television network, and the connections 18 are standard telephone links.

In another embodiment of the present invention, the master catalog server 12 and the central processing server 24 are a single server computer. Likewise, one of the regional servers 16 may serve a dual function as the master catalog server, or even provide the functionality of the master catalog server 12 and the central processing server 24.

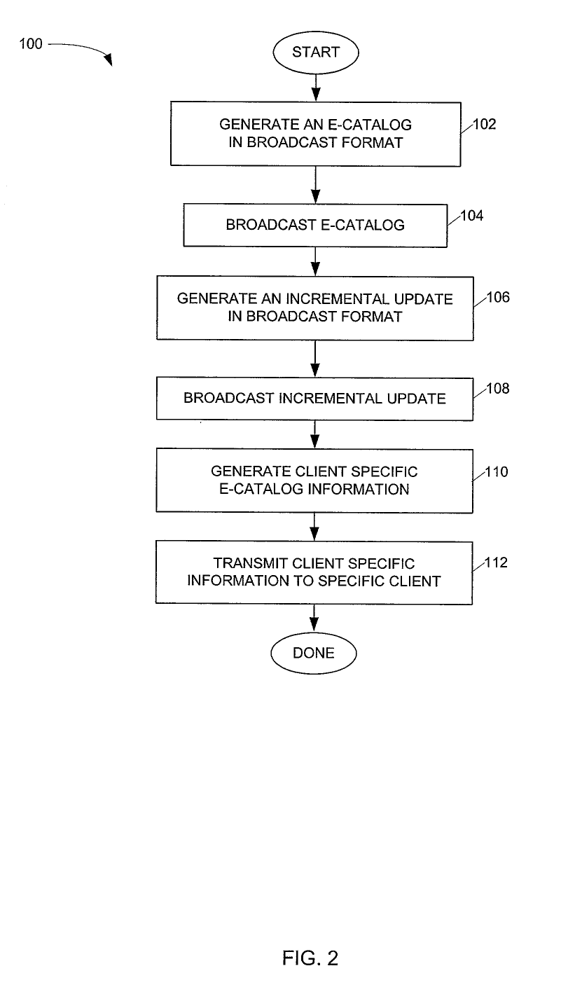

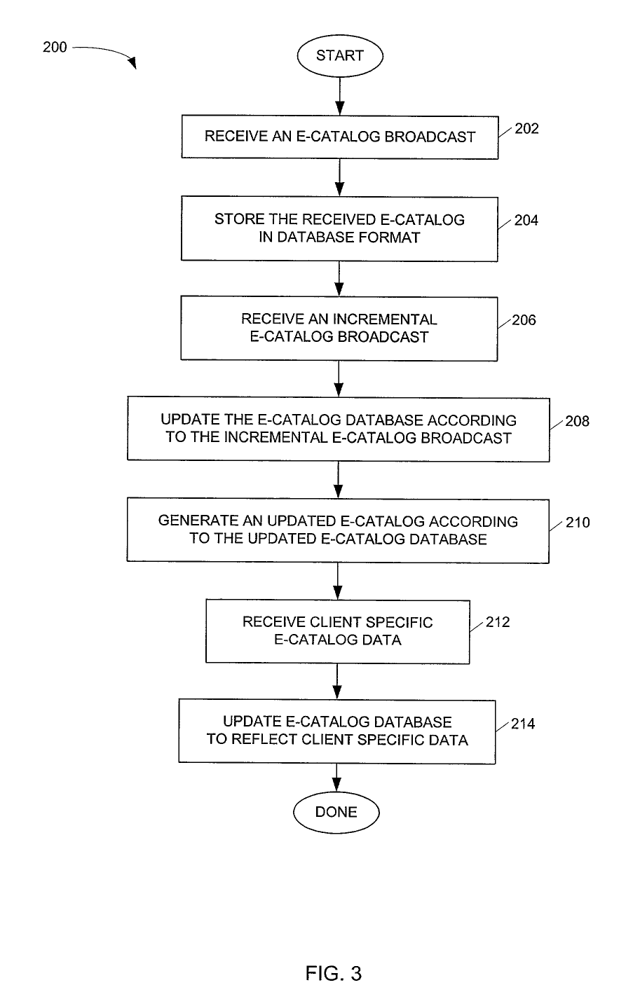

With reference to FIGS. 2 and 3, broadcast methods for providing an electronic catalog capable of incremental updates to a plurality of clients will now be described. The present invention provides electronic catalog data (e.g., complete or incremental data) via a client generic data broadcast method. By storing the electronic catalog in a format where different data types may be directly accessed, the end user of the electronic catalog may be provided catalog updates through the broadcast, receipt and processing of only those portions of the electronic catalog that have undergone changes from one catalog version to the next.

FIG. 2 is a flow chart illustrating a method 100 for providing an electronic catalog capable of incremental updates to a plurality of clients. In a first step 102 a catalog server generates an electronic catalog in a format suitable for broadcast to a plurality of clients in a client generic format. The electronic catalog typically has a plurality of data types stored with individually accessible data entries. The use of a client generic format greatly reduces bandwidth requirements enabling broadcast to a greater number of clients than feasible through a client specific format. Several preferred techniques for client generic broadcast and processing of client generic broadcast data are described in more detail in Hoang's related U.S. patent application Ser. Nos. 09/584,832, 09/709,948, 09/841,792, and 09/870,879, which applications are incorporated herein by reference.

Once the electronic catalog is generated in step 102, in a step 104 a master catalog server broadcasts the electronic catalog over a broadcast network intended to reach the plurality of clients. This broadcast network may take the form of a commercial satellite network, a cable network, other digital television networks, or WAN networks such as the Internet, etc. The clients may include computers, web browsers, STBs, or other devices attached to the network. As described in more detail below with reference to FIG. 3, the clients generate an electronic catalog in a format suitable for use by an end user or customer.

In step 104 a portion of the network bandwidth independent of the number of clients is allocated for purpose of the electronic catalog data broadcast. The present invention contemplates that bandwidth may be allocated and the electronic catalog broadcast at periodic intervals. For example, the electronic catalog may be broadcast regularly during a low use time of day. Alternatively, the electronic catalog may be broadcast repeatedly at a low bandwidth rate in a dedicated channel or incorporated with other information.

In a next step 106 the catalog server generates an incremental update applicable to the electronic catalog in a format suitable for broadcast to the plurality of clients. The incremental update indicates changes to be made to a portion of the electronic catalog present at a plurality of clients, rather than providing an entirely new catalog to all clients, or providing client specific incremental updates. In a step 108 catalog server broadcasts the incremental update over the broadcast network intended to reach the plurality of clients.

Steps 102 through 108 enable provision of a client generic electronic catalog with updates to a plurality of clients through incremental updates. Hence for client generic portions of an electronic catalog, the present invention de-couples the relationship between bandwidth requirements and number of clients. In some situations, it may be desirable to transmit client specific electronic catalog information. Certain embodiments of the present invention contemplate transmission of client specific electronic catalog information through a separate mechanism, thereby combining the bandwidth efficiencies of client generic broadcast methods with client specific information. To accomplish this, an optional step 110 generates client specific electronic catalog information in a format suitable for transmission to a specific client. To complete this process, another optional step 112 transmits the client specific electronic catalog information to each specific client as necessary. It will be appreciated that to accomplish step 112, a portion of the network bandwidth must be allocated to each client requiring client specific bandwidth. It is contemplated that the client specific electronic catalog data may be generated at and broadcast from either a master server or a regional server.

With reference to FIG. 3, a computer implemented method 200 for providing an electronic catalog capable of incremental updates to an end user of a specific client is described. The computer implemented method 200 is performed at a client computer such as a web browser or a set top box.

In a first step 202 a client receives a complete electronic catalog that has been broadcast in a client generic format. To receive the broadcast, the client must tune in to that portion of the network bandwidth allocated to electronic catalog broadcast. Alternatively, the electronic catalog data may be interleaved with other data the user is presently receiving and accessing. In a next step 204, the client stores the complete electronic catalog in an electronic catalog database particularly suited for incremental updates. For example, the electronic catalog database may arrange different data types such as video, graphics, audio, text and navigational information such that database entries of differing types are individually accessible. Such an electronic catalog database is described above with reference to FIG. 1, and more detail will be provided with reference to FIG. 4 below.

In preferred embodiments, steps 202 and 204 may occur simultaneously; i.e., the client may be receiving electronic catalog data and arranging the data in parallel. It is contemplated that the electronic catalog data may be received over a period of several time intervals. For example, the complete electronic catalog broadcast may be broken up over several intervals, or the electronic catalog data may be repeatedly transmitted and the client accesses the electronic catalog data only during convenient time intervals. In light of the present teaching, those skilled in the art will readily recognize the variety of suitable methods for accessing the electronic catalog data in the variety of ways in which such data may be broadcast. In any event, after a certain period the client can receive and arrange an entire electronic catalog. Once a complete electronic catalog is received, the client is operable to generate and provide an electronic catalog to a user, as well as receive and process orders.

With further reference to FIG. 3, in a step 206 the client receives an incremental update to said electronic catalog via a client generic incremental update broadcast. Similar to step 202 described above, the incremental electronic catalog update may be received over several time intervals. For example, the incremental update broadcast may be broken up over several intervals, or the incremental update data may be repeatedly transmitted with the client accessing the incremental update data only during convenient time intervals. The present invention contemplates that the electronic catalog data and the incremental update data may be received over the same program channel, or may be received over different program channels. Furthermore, these may be fixed program channels or may even be broadcast over available channels with the client being capable of searching for and recognizing desired data.

In any event, after a certain period the client has received a sufficient portion of the incremental update to, in a step 208, begin to update the electronic catalog database. Once the electronic catalog has been updated to reflect the received incremental update data, in a step 210 the client may generate an updated electronic catalog for presentation to a user of the client.

The present invention further contemplates the optional inclusion of client specific information within the electronic catalog. Accordingly, in a step 212 the client receives client specific electronic catalog data. This data may be received via the network, or may be provided as user input or generated through another mechanism at the client. In a step 214, the client updates the electronic catalog database to reflect any desired client specific electronic catalog data.

FIG. 4 illustrates an abstract database diagram of an electronic catalog database 300 stored on a client computer in accordance with one embodiment of the present invention. To render the electronic catalog database readily suitable for incremental updates, the electronic catalog database 300 may be arranged having a variety of data types, each with specific data entries accessible for update. In FIG. 4, the electronic catalog database 300 includes graphic data 302, video data 304, audio data 306, text data 308, navigation data 310, and client specific data 312. While these are likely data types, it should be apparent that many of these are optional and arise under a specific electronic catalog. Additional data types may be used for generating an electronic catalog.

With the exception of suitability for incremental updating, no one particular database structure is required to practice the present invention. For example, the electronic catalog may be stored in an HTML or XTML format. In light of the teaching of the present invention, those skilled in the art will readily understand how to implement such a database according to a variety of database techniques. Accordingly, the electronic catalog database 300 of FIG. 4 is merely a abstract image conveying a nature of the electronic database 300 relevant to the present invention.

The navigation data 310 provides a database map or description for how to interconnect and navigate about the variety of data found in the electronic catalog database. Thus the navigation data 310 enables the client to generate an electronic catalog from the other data types so that a user may access, peruse, place orders from, and otherwise make use of the electronic catalog.

In preferred embodiments of the present invention, all or most of the electronic catalog data will be generic and applicable to a plurality of clients. This criteria insures efficient use of network bandwidth in that client generic data broadcast is enabled. However, it may be desirable and is optional to client customize the electronic catalog through the use of client specific data. The client specific data 312 is data that enables client customization of an electronic catalog.

The region id lookup table 314 provides an index or reference between regional ids, client ids, and regional server contact information. The id lookup table 314 may provide a list matching all known clients to a region, or may simply list the specific regional server the host client must utilize. The region id lookup table 314 may further include backup or secondary regional servers for use when a preferred regional server is unavailable. In one preferred embodiment, the regional server information is a dial-in telephone line associated with the regional server.

FIG. 5 is a flow chart illustrating a method 400 for enabling a customer or user to interactively utilize an electronic catalog, including localized processing of customer requests. In a first step 402, a client receives a user request to access an electronic catalog. In a step 404, the client retrieves the electronic catalog data from the electronic catalog database and generates an electronic catalog for access by the user. In a next step 406, the user is allowed to interactively navigate throughout the electronic catalog. In a step 408, the client receives a user request such as a purchase request, an order confirmation request, a cancel order request, etc.

Having received a user request, in a step 410 the client marshals the user request in a format suitable for network transmission. In a step 412, the client determines the appropriate regional server for which to transmit the user request. In a next step 414, the client establishes a communication link with the regional server and transmits the user request. In a step 416, the regional server receives and processes the user request. For example, the user request may be a purchase order for a specific product found in a local warehouse. The regional server will facilitate shipping of the requested product directly from a local server.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

We claim:

1. An electronic catalog system comprising:
a plurality of electronic catalog clients;
a master catalog server storing electronic catalog data, said master catalog capable of generating said electronic catalog data in a format suitable for a client generic broadcast to said plurality of electronic catalog clients, said client generic broadcast utilizing an amount of bandwidth that is independent of the number of said plurality of electronic catalog clients; and
a broadcast network coupling said master electronic catalog server with said plurality of clients.

2. An electronic catalog system as recited in claim 1, wherein at least one of said plurality of electronic catalog clients is a set-top-box.

3. An electronic catalog system as recited in claim 1, wherein at least one of said electronic catalog clients is a personal computer.

4. An electronic catalog system as recited in claim 1, wherein at least one of said electronic catalog clients is a web browser.

5. An electronic catalog system as recited in claim 1, wherein at least one of said electronic catalog clients is a personal digital assistant.

6. An electronic catalog system as recited in claim 1, wherein said electronic catalog data includes a complete electronic catalog.

7. An electronic catalog system as recited in claim 1, wherein said electronic catalog data includes incremental catalog update information.

8. An electronic catalog system as recited in claim 1, wherein said broadcast network is a digital television network.

9. An electronic catalog system as recited in claim 1 wherein said broadcast network is a wide area network.

10. An electronic catalog system as recited in claim 1, further including:
a certain region including at least one of said electronic catalog clients;
at least one regional server associated with said certain region, said at least one regional server operable to process customer orders received form said electronic catalog clients;
a communications link for providing communications between said at least one of said electronic catalog clients and said at least one regional server; and
wherein said at least one client is operable to utilize said communications link to transmit customer orders to said at least one regional server.

11. An electronic catalog system as recited in claim 10, wherein said certain region is defined with respect to geographic proximity of clients present within said certain region.

12. An electronic catalog system as recited in claim 10, wherein said communications link is a telephone line.

13. An electronic catalog system as recited in claim 10, wherein said certain region is one of a plurality of regions each comprising a multiplicity of clients and a regional server, said plurality of regional servers connected through a wide area network

14. An electronic catalog system as recited in claim 13, further comprising a central processing server coupled to said plurality of regional servers, said central processing server operable to facilitate transactions performed by said regional servers.

15. An electronic catalog system comprising:
a master catalog server for maintaining electronic catalog data including an electronic catalog and incremental electronic catalog updates, said master catalog server operable to broadcast said electronic catalog data;
a broadcast network;
an electronic catalog client coupled with said master catalog server via said broadcast network, said electronic catalog client operable to receive said electronic catalog data, maintain an electronic catalog database, update said electronic catalog database according to incremental catalog updates, generate and provide an up to date electronic catalog to a user, and receive order requests from said user related to said up to date electronic catalog;
a regional server operable to process order requests; and
a communication medium suitable for bi-directionally coupling said regional server to said electronic catalog client.

16. An electronic catalog system as recited in claim 15, wherein said electronic catalog client is a set-top-box, said broadcast network is a digital television network, and said communication medium is a telephone line.

17. An electronic catalog client operable to receive and maintain electronic catalog data, said electronic catalog data including both an electronic catalog broadcast corresponding to a complete electronic catalog and an incremental electronic catalog broadcast corresponding to an incremental update to said complete electronic catalog, said electronic catalog further operable to generate an up to date electronic catalog from said complete electronic catalog and said incremental update, said electronic catalog still further operable to provide said up to date electronic catalog to a user, and receive order requests from said user related to said up to date electronic catalog.

18. An electronic catalog client as recited in claim 17, wherein said electronic catalog is a personal computer.

19. An electronic catalog client as recited in claim 17, wherein said electronic catalog is a set-top-box.

20. An electronic catalog client as recited in claim 17, wherein said electronic catalog is a personal digital assistant (PDA).

21. A master electronic catalog server for use in an electronic catalog system, the master electronic catalog server characterized in that:
said master electronic catalog server is operable to generate, for broadcast to a plurality of clients in a client generic format, a master electronic catalog; and
said master electronic catalog server is operable to generate, for broadcast to said plurality of clients in said client generic format, an incremental update to said master electronic catalog.

22. A regional server for use in an electronic catalog system having a master server catalog operable to broadcast electronic catalog information to plurality of electronic catalog clients located within a region associated with said regional server, said regional server characterized in that:
said regional server is operable to establish bi-directional communications with said plurality of electronic catalog clients located within said region associated with said regional server;
said regional server is operable to receive order requests from said plurality of electronic catalog clients located within said region associated with said regional server, said order requests related to said electronic catalog information; and
said regional server is operable to locally process said order requests.

23. A computer implemented method for providing an electronic catalog capable of incremental updates to a plurality of clients, said computer implemented method comprising the acts of:
generating an electronic catalog in a format suitable for broadcast to a plurality of clients, said electronic catalog having a plurality of data types;
broadcasting said electronic catalog over a network intended to reach said plurality of clients;
generating an incremental update to said electronic catalog in a format suitable for broadcast to said plurality of clients, said incremental update changing a portion of said electronic catalog; and
broadcasting said incremental update over said network intended to reach said plurality of clients,
whereby said plurality of clients can provide an updated catalog to end users through receipt of said incremental update.

24. A computer implemented method for providing an electronic catalog as recited in claim 23, wherein the act of generating an electronic catalog in a format suitable for broadcast to a plurality of clients includes the sub-act of preparing a delivery matrix defining a data transmission sequence suitable for broadcast to said plurality of clients said electronic catalog in a non client specific manner, whereby said act of broadcasting said electronic catalog over a network intended to reach said plurality of clients requires an amount of transmission bandwidth that is independent of the number of said plurality of clients.

25. A computer implemented method as recited in claim 23, wherein said plurality of data types includes electronic catalog navigation and at least one of video, audio, text and graphics.

26. A computer implemented method as recited in claim 23, wherein said act of broadcasting said electronic catalog over a network intended to reach said plurality of clients is accomplished by broadcasting said electronic catalog during at least one predefined time interval.

27. A computer implemented method as recited in claim 26 wherein said at least one predefined time interval is a time interval predicted to be a client low use time interval.

28. A computer implemented method as recited in claim 23 wherein said act of broadcasting said electronic catalog over a network intended to reach said plurality of clients is accomplished by repeatedly broadcasting said electronic catalog.

29. A computer implemented method as recited in claim 23 wherein said act of broadcasting said electronic catalog over a network intended to reach said plurality of clients is accomplished by broadcasting said electronic catalog over a predefined channel program.

30. A computer implemented method as recited in claim 23 wherein said act of broadcasting said electronic catalog over a network intended to reach said plurality of clients is accomplished by broadcasting said electronic catalog over an available channel program.

31. A computer implemented method as recited in claim 23 wherein said act of broadcasting said electronic catalog over a network intended to reach said plurality of clients is accomplished by broadcasting said electronic catalog interleaved with other data being broadcast to said plurality of clients.

32. A computer implemented method for providing an electronic catalog as recited in claim 23, wherein the act of generating an incremental update to said electronic catalog in a format suitable for broadcast to a plurality of clients includes the sub-act of preparing a delivery matrix defining a data transmission sequence suitable for broadcasting to said plurality of clients said incremental update in a non client specific manner, whereby said act of broadcasting said incremental update over said network intended to reach said plurality of clients requires an amount of transmission bandwidth that is independent of the number of said plurality of clients.

33. A computer implemented method as recited in claim 23, wherein said act of broadcasting said incremental update over a network intended to reach said plurality of clients is accomplished by broadcasting said incremental update during at least one predefined time interval.

34. A computer implemented method as recited in claim 33 wherein said at least one predefined time interval is a time interval predicted to be a client low use time interval.

35. A computer implemented method as recited in claim 23 wherein said act of broadcasting said incremental update over a network intended to reach said plurality of clients is accomplished by repeatedly broadcasting said incremental update.

36. A computer implemented method as recited in claim 23 wherein said act of broadcasting said incremental update over a network intended to reach said plurality of clients is accomplished by broadcasting said incremental update over a predefined channel program.

37. A computer implemented method as recited in claim 23 wherein said act of broadcasting said incremental update over a network intended to reach said plurality of clients is accomplished by broadcasting said incremental update over an available channel program.

38. A computer implemented method as recited in claim 23 wherein said act of broadcasting said incremental update over a network intended to reach said plurality of clients is accomplished by broadcasting said incremental update interleaved with other data being broadcast to said plurality of clients.

39. A computer implemented method as recited in claim 23 wherein said electronic catalog and said incremental update are broadcast over the same program channel.

40. A computer implemented method as recited in claim 23 wherein said electronic catalog and said incremental update are broadcast over different program channels.

41. A method for providing an electronic catalog capable of incremental updates to a plurality of clients as recited in claim 23, said method further comprising the acts of: at a specific client coupled to said network:
receiving said electronic catalog via said electronic catalog broadcast;
storing said electronic catalog in a database arranged such that database entries of differing data types are individually accessible;
receiving said incremental update to said electronic catalog via said incremental update broadcast;
generating an updated database by updating said database according to said incremental update; and
generating an updated electronic catalog from said updated database.

42. A computer implemented method for providing an electronic catalog capable of incremental updates, said method comprising the acts of:
receiving an electronic catalog having a plurality of data types;
storing said electronic catalog in a database arranged such that database entries of differing data types are individually accessible;
receiving an incremental update to said electronic catalog, said incremental update including at least one database entry update;
generating an updated database by updating said database according to said incremental update; and
generating an updated electronic catalog from said updated database.

43. A computer implemented method for providing an electronic catalog capable of incremental updates as recited in claim 42, the computer implemented method further comprising the acts of:
enabling a user to interactively access said electronic catalog; and
receiving order information from said user related to said electronic catalog.

44. A computer implemented method for providing an electronic catalog capable of incremental updates as recited in claim 43, the computer implemented method further comprising the acts of:
establishing a bi-directional communication link with a regional server; and
transmitting said order information to said regional server.

45. A computer implemented method for providing an electronic catalog capable of incremental updates as recited in claim 44, the computer implemented method further comprising the act of processing said order information at said regional server.
